(19) United States
(12) Patent Application Publication
(10) Pub. No.: US 2018/0332266 A1
(43) Pub. Date: Nov. 15, 2018

(54) SPATIALLY TRANSLATED DIMENSIONS OF UNSEEN OBJECT

(71) Applicant: DAQRI, LLC, Los Angeles, CA (US)

(72) Inventor: Brian Mullins, Altadena, CA (US)

(21) Appl. No.: 15/595,657

(22) Filed: May 15, 2017

(51) Int. Cl. H04N 13/00; H04N 13/02

(52) U.S. Cl. CPC H04N 13/0011; G01S 15/931; H04N 13/0271; H04N 13/0217

(57) ABSTRACT

Disclosed are systems, methods, and non-transitory computer-readable media for presenting spatially translated dimensions of an unseen object. A viewing device captures, with one or more sensors affixed to a vehicle, sensor data describing a distance between the vehicle and a physical object. The viewing device generates, based on the sensor data, a virtual model representing a position of at least a portion of the vehicle in relation to the physical object. The viewing device presents the virtual model on a display in the vehicle. The viewing device captures, with the one or more sensors affixed to the vehicle, updated sensor data describing an updated distance between the vehicle and the physical object, and updates the virtual model presented on the display based on the updated sensor data.

### TECHNICAL FIELD

The subject matter disclosed herein generally relates to presenting virtual content to augment reality. Specifically, the present disclosure addresses systems and methods for presenting spatially translated dimensions of an unseen object.

### BACKGROUND

Augmented reality (AR) systems present virtual content to augment a user's reality. One use for AR is to aid users while operating a vehicle. For instance, augmented reality can be presented on a heads up display (HUD) to provide a user with directions to a desired destination. Virtual arrows or other indicators can be presented on the HUD to augment the user's physical world and provide a route the user should follow to reach their desired destination. While AR works well to guide a user when overlaid over the user's physical world, in some instances a user cannot see the physical obstacles in their path. For example, a physical obstacle may be out of the user's line of sight when a user is moving in reverse.

### BRIEF DESCRIPTION OF THE SEVERAL VIEWS OF THE DRAWINGS

Example methods and systems of spatially translating dimensions of unseen objects are disclosed. In the following description, for purposes of explanation, numerous specific details are set forth in order to provide a thorough understanding of example embodiments. It will be evident, however, to one skilled in the art that the present embodiments can be practiced without these specific details.

In some example FIG. 1 is a block diagram illustrating an example of a network environment suitable for presenting virtual content to augment a user's reality, according to some example embodiments.

FIG. 2 is a block diagram illustrating an example embodiment of a viewing device, according to some embodiments.

FIG. 3 is a block diagram illustrating an example embodiment of an AR application, according to some embodiments.

FIG. 4 is an example method for presenting spatially translated dimensions of an unseen object, according to some example embodiments.

FIG. 5 is an example method for presenting navigation instructions based on an unseen object, according to some example embodiments.

FIG. 6 is an example method for presenting spatially translated dimensions of an unseen object, according to some example embodiments.

FIG. 7 is a screenshot of a HUD presenting a virtual model of an unseen physical object, according to some embodiments.

FIG. 8 is another screenshot of a HUD presenting a virtual model of an unseen physical object, according to some embodiments.

FIG. 9 is screenshot of a HUD presenting a virtual model of an unseen physical object and an alert message, according to some embodiments.

FIG. 10 is screenshot of a HUD presenting a virtual model of an unseen physical object and navigation instructions, according to some embodiments.

FIG. 11 is screenshot of a HUD presenting a virtual model of an unseen physical object, according to some embodiments.

FIG. 12 is a diagrammatic representation of a computing device in the example form of a computer system within which a set of instructions for causing the computing device to perform any one or more of the methodologies discussed herein may be executed.

### DETAILED DESCRIPTION

Example methods and systems are directed to presenting spatially translated dimensions of an unseen object. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Augmented reality (AR) allows a user to augment reality with virtual content. Virtual content can be presented on a transparent display of a viewing device to augment the user's real world environment. As an example, virtual content presented on a heads up display (HUD) in an automobile can present the user with arrows or other indicators that provide the user with directions to a desired destination. In addition to augmenting the real world environment that is visible through the display (e.g., augmenting physical objects that are visible through the windshield), a viewing device can also present the user with spatially translated dimensions of an unseen physical object. For example, a driver that is parallel parking may not be able to see the curb and so the viewing device can present virtual content on the HUD that depicts the curb in relation to the user's vehicle. Accordingly, the user can utilize the presented virtual content to aide in parking the vehicle.

To present the spatially translated dimensions of an unseen physical object, the viewing device can utilize sensors attached to the vehicle to gather sensor data describing the distance between the vehicle and the physical object. The viewing device utilizes the sensor data to generate a virtual model representing a position of the vehicle in relation to the physical object. The generated virtual model is presented on the HUD to aid the user in navigating the vehicle in relation to the physical object.

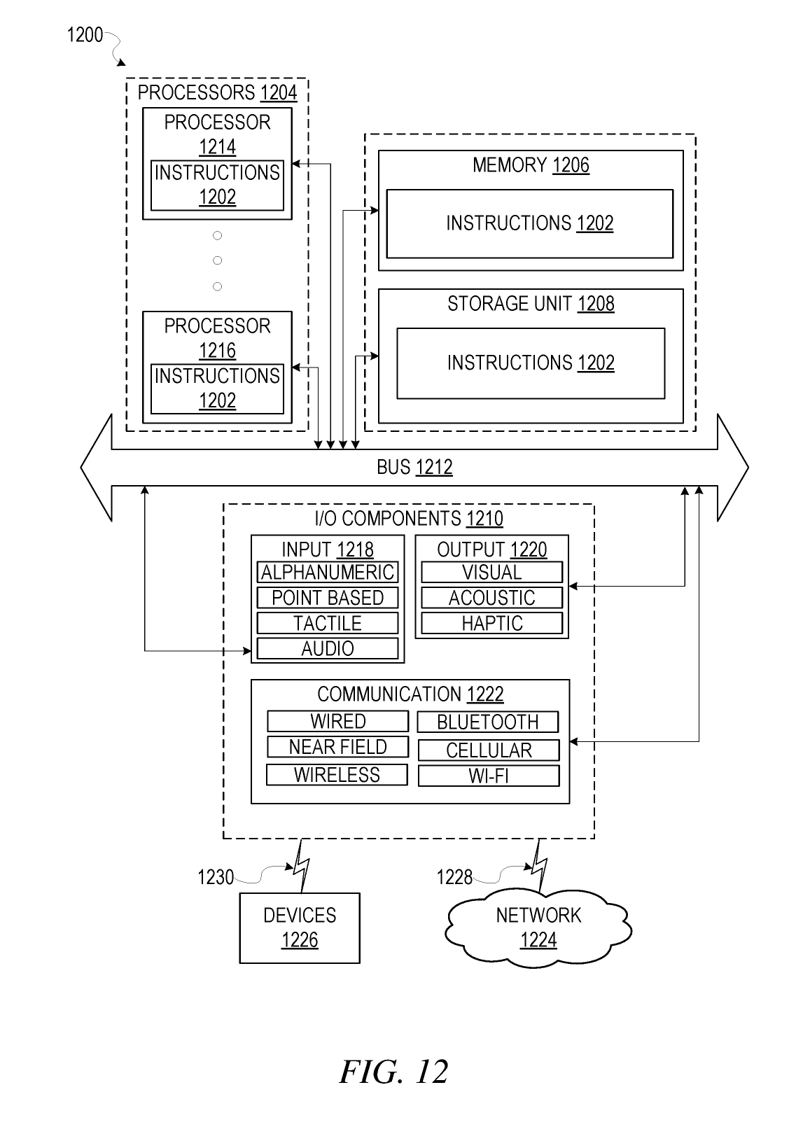

FIG. 1 is a block diagram illustrating an example of a network environment suitable for presenting virtual content to augment a user's reality, according to some example embodiments. The network environment 100 includes a viewing device 102 and a server 110, communicatively coupled to each other via a network 108. The viewing device 102 and the server 110 may each be implemented in a computer system, in whole or in part, as described below with respect to FIG. 12.

The server 110 may be part of a network-based system. For example, the network-based system may be or include a cloud-based server system that provides additional information, such as three-dimensional (3D) models or other virtual content, to the viewing device 102.

The viewing device 102 can be used by the user 106 to augment the user's reality. The user 106 may be a human user (e.g., a human being), a machine user (e.g., a computer configured by a software program to interact with the viewing device 102), or any suitable combination thereof (e.g., a human assisted by a machine or a machine supervised by a human). The user 106 is not part of the network environment 100, but is associated with the viewing device 102.

The viewing device 102 may be a computing device with a camera and a transparent display, such as a tablet, smartphone, or a wearable computing device (e.g., helmet or glasses). In another example embodiment, the viewing device 102 may be hand held or may be removably mounted to the head of the user 106 (e.g., a head-mounted viewing device). In another example embodiment, the viewing device 102 may be a computing device integrated in a vehicle, such as an automobile, to provide virtual content on a heads up display (HUD).

In one example, the display may be a screen that displays what is captured with a camera of the viewing device 102. In another example, the display of the viewing device 102 may be transparent or semi-transparent, such as in lenses of wearable computing glasses, the visor or a face shield of a helmet, or a windshield of a car. In this type of embodiment, the user 106 may simultaneously view virtual content presented on the display of the viewing device 102 as well as a physical object 104 in the user's 106 line of sight in the real-world physical environment.

The viewing device 102 may provide the user 106 with an augmented reality experience. For example, the viewing device 102 can present virtual content on the display of the viewing device 102 that the user 106 can view in addition to physical objects 104 that are in the line of sight of the user 106 in the real-world physical environment. Virtual content can be any type of image, animation, etc., presented on the display. For example, virtual content can include a virtual model (e.g., 3D model) of an object.

The viewing device 102 can present virtual content on the display to augment a physical object 104. For example, the viewing device 102 can present virtual content to create an illusion to the user 106 that the physical object 104 is changing colors, emitting lights, etc. As another example, the viewing device 102 can present virtual content on a physical object 104 that provides information about the physical object 104, such a presenting a name or a restaurant over the physical location of the restaurant. As another example, the viewing device can present arrows, lines, or other directional indicators over a street to provide the user 106 with directions to a desired destination.

The physical object 104 may include any type of identifiable objects such as a 2D physical object (e.g., a picture), a 3D physical object (e.g., a factory machine, table, cube, building, street, etc.), a location (e.g., at the bottom floor of a factory), or any references (e.g., perceived corners of walls or furniture) in the real-world physical environment.

The viewing device 102 can present virtual content in response to detecting one or more identified objects (e.g., physical object 104) in the physical environment. For example, the viewing device 102 may include optical sensors to capture images of the real-world physical environment and computer vision recognition to identify physical objects 104.

In one example embodiment, the viewing device 102 locally analyzes captured images using a local content dataset or any other dataset previously stored by the viewing device 102. The local content dataset may include a library of virtual content associated with real-world physical objects 104 or references. For example, the local content dataset can include image data depicting real-world physical objects 104, as well as metadata describing the real-world objects. The viewing device 102 can utilize the captured image of a physical object to search the local content dataset to identify the physical object and its corresponding virtual content.

In one example, the viewing device 102 can analyze an image of a physical object 104 to identify feature points of the physical object 104. The viewing device 102 can utilize the identified feature points to identify a corresponding real-world physical object from the local content dataset. The viewing device 102 may also identify tracking data related to the physical object 104 (e.g., GPS location of the viewing device 102, orientation, distance to the physical object 104).

If the captured image is not recognized locally by the viewing device 102, the viewing device 102 can download additional information (e.g., virtual content) corresponding to the captured image, from a database of the server 110 over the network 108.

In another example embodiment, the physical object 104 in the image is tracked and recognized remotely at the server 110 using a remote dataset or any other previously stored dataset of the server 110. The remote content dataset may include a library of virtual content or augmented information associated with real-world physical objects 104 or references. In this type of embodiment, the viewing device 102 can provide the server with the captured image of the physical object 104. The server 110 can use the received image to identify the physical object 104 and its corresponding virtual content. The server 110 can then return the virtual content to the viewing device 102.

The viewing device 102 can present the virtual content on the display of the viewing device 102 to augment the user's 106 reality. For example, the viewing device 102 can present the virtual content on the display of the viewing device 102 to allow the user 106 to simultaneously view the virtual content as well as the real-world physical environment in the line of sight of the user 106.

In addition to augmenting a physical object 104 that is in the user's line of sight, the viewing device 102 can also present a virtual model depicting a physical object 104 that is not in the user's line of sight. A virtual model can be a visual representation of the physical object 104, such as 3D model. A viewing device 102 incorporated into a vehicle can present a virtual model depicting a location of a curb that is out of the line of sight of the user 106 when a user 106 is attempting to parallel park. The virtual model can depict the physical dimensions of the curb as well as a position of the curb in relation to the vehicle. The user 106 can utilize the virtual model as an aid in navigation the vehicle in relation to the curb.

The viewing device 102 gathers sensor data describing a distance of a physical object 104 from the vehicle. Sensors designed to determine a distance to a physical object 104 can be affixed at various positions on the perimeter of the vehicle. The viewing device 102 gathers sensor data from the sensors to generate a virtual model representing the physical object 103 and a position of the physical object 104 in relation to the vehicle. The viewing device 102 presents the virtual object on a display, such as a HUD, to aid the user 106 in navigating the vehicle in relation to the physical object 104 that is not in the user's line of sight.

The viewing device 102 updates the virtual model as the vehicle moves. For example, the viewing device 102 can gather updated sensor data as the vehicle moves and generate an updated virtual model based on the updated sensor data. The viewing device 102 may also monitor movements of the vehicle to determine an updated position of the vehicle in relation to the physical object 104. The viewing device 102 presents the updated virtual model on the display, thereby providing the user 106 with a continuous depiction of the position of the vehicle in relation to the physical object 104.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 12. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., viewing device 102). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

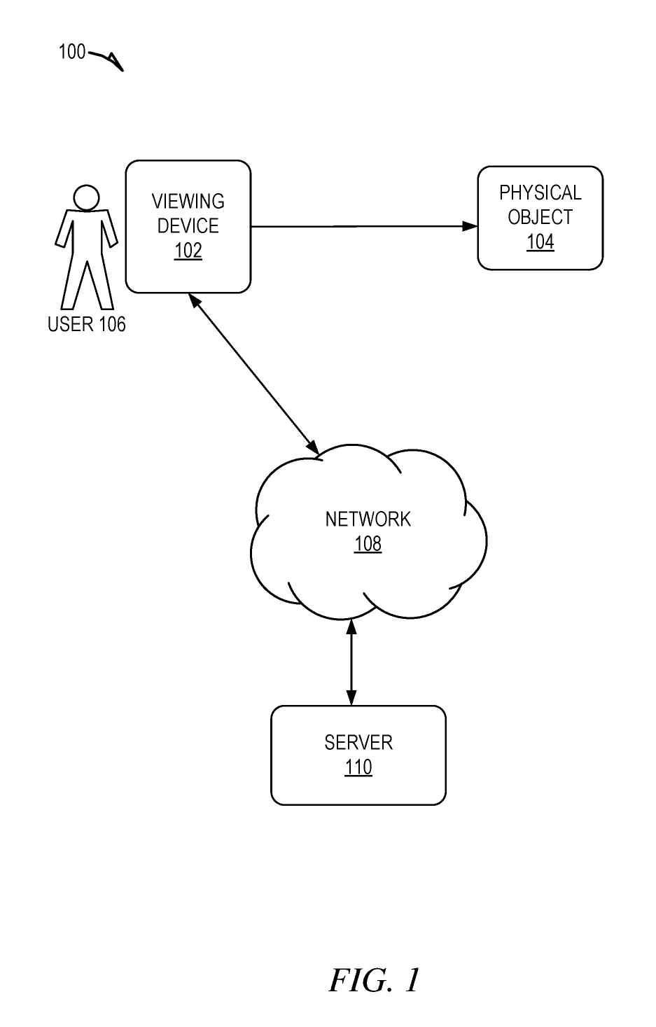

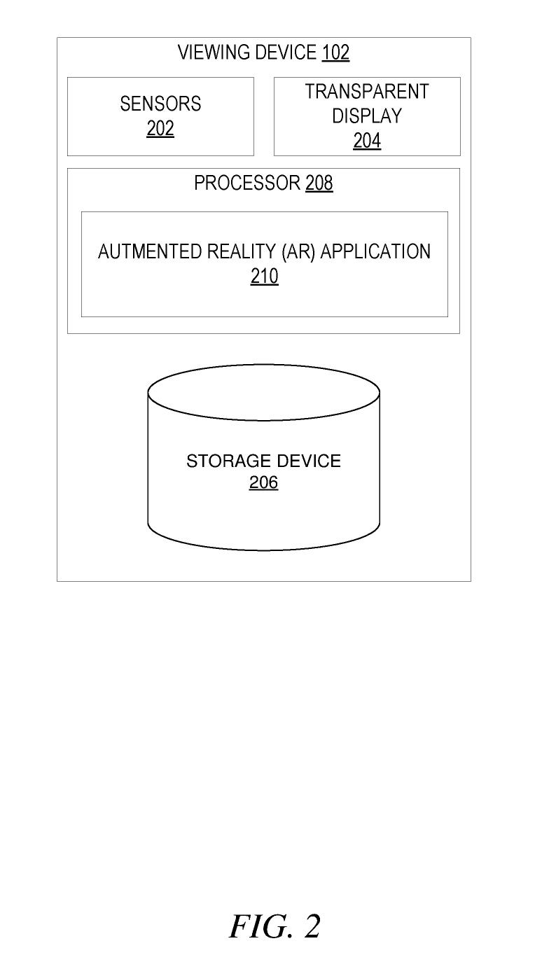

FIG. 2 is a block diagram illustrating an example embodiment of a viewing device 102, according to some embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the viewing device 102 to facilitate additional functionality that is not specifically described herein. Furthermore, the various functional modules depicted in FIG. 2 may reside on a single computing device or may be distributed across several computing devices in various arrangements such as those used in cloud-based architectures.

The viewing device 102 includes sensors 202, a transparent display 204, a computer processor 208, and a storage device 206. The viewing device 102 can be a wearable device, such as a helmet, a visor, or any other device that can be mounted to the head of a user 106. The viewing device 102 may also be a mobile computing device, such as a smartphone or tablet. The viewing device may also be a computing device integrated into a vehicle, such as an automobile, motorcycle, plane, boat, recreational vehicle (RV), etc.

The sensors 202 can include any type of known sensors. For example, the sensors 202 can include a thermometer, an infrared camera, a barometer, a humidity sensor, an electroencephalogram (EEG) sensor, a proximity or location sensor (e.g., near field communication, GPS, Bluetooth, Wi-Fi), an optical sensor (e.g., camera), an orientation sensor (e.g., gyroscope), an audio sensor (e.g., a microphone), or any suitable combination thereof. For example, the sensors 202 may include a rear-facing camera and a front-facing camera in the viewing device 102. As another example, the sensors can include multiple sensors placed at various points of a vehicle that determine distance from a physical object, such as a depth sensor or radar sensor. It is noted that the sensors described herein are for illustration purposes and the sensors 202 are thus not limited to the ones described.

The transparent display 204 includes, for example, a display configured to display virtual images generated by the processor 208. In another example, the transparent display 204 includes a touch-sensitive surface to receive a user input via a contact on the touch-sensitive surface. The transparent display 204 can be positioned such that the user 106 can simultaneously view virtual content presented on the transparent display and a physical object 104 in a line-of-sight of the user 106. For example, the transparent display 204 can be a HUD in an automobile or other vehicle that presents virtual content on a windshield of the vehicle while also allowing a user 106 to view physical objects 104 through the windshield.

The processor 208 includes an AR application 210 configured to present virtual content on the transparent display 204 to augment the user's 106 reality. The AR application 210 can receive data from sensors 202 (e.g., an image of the physical object 104, location data, etc.), and use the received data to identify a physical object 104 and present virtual content on the transparent display 204.

To identify a physical object 104, the AR application 210 determines whether an image captured by the viewing device 102 matches an image locally stored by the viewing device 102 in the storage device 206. The storage device 206 can include a local content dataset of images and corresponding virtual content. For example, the viewing device 102 can receive a content data set from the server 110, and store the received content data set in the storage device 206.

The AR application 210 can compare a captured image of the physical object 104 to the images locally stored in the storage device 206 to identify the physical object 104. For example, the AR application 210 can analyze the captured image of a physical object 104 to identify feature points of the physical object. The AR application 210 can utilize the identified feature points to identify physical object 104 from the local content dataset.

In some embodiments, the AR application 210 can identify a physical object 104 based on a detected visual reference (e.g., a logo or QR code) on the physical object 104 (e.g., a chair). The visual reference may also be referred to as a marker and may consist of an identifiable image, symbol, letter, number, machine-readable code. For example, the visual reference may include a bar code, a quick response (QR) code, or an image that has been previously associated with the virtual content.

If the AR application 210 cannot identify a matching image from the local content dataset, the AR application 210 can provide the captured image of the physical object 104 to the server 110. The server 100 uses the captured image to search a remote content dataset maintained by the server 110.

The remote content dataset maintained by the server 110 can be larger than the local content dataset maintained by the viewing device 102. For example, the local content dataset maintained by the viewing device 102 can include a subset of the data included in the remote content dataset, such as a core set of images or the most popular images determined by the server 110.

Once the physical object 104 has been identified by either the viewing device 102 or the server 110, the corresponding virtual content can be retrieved and presented on the transparent display 204 to augment the user's 106 reality. The AR application 210 can present the virtual content on the transparent display 204 to create an illusion to the user 106 that the virtual content is in the user's real world, rather than virtual content presented on the display. For example, the AR application 210 can present arrows or other directional indicators to create the illusion that the arrows are present on the road in front of the user 106.

In addition to augmenting a physical object 104 that is in the user's line of sight, the AR application 210 can also present virtual content depicting a physical object 104 that is not in the user's line of sight. For example, a viewing device 102 incorporated into a vehicle can present a virtual model depicting a curb that is out of the line of sight of the user 106. The virtual model can depict the location of the curb in relation to the vehicle, thereby aiding the user 106 in navigating the vehicle in relation to the curb.

The AR application 210 gathers sensor data from the sensors 202 that describes a distance of the physical object 104 from the vehicle. Sensors 202 designed to determine a distance to a physical object 104 can be located at various positions on the perimeter of the vehicle. For example, the sensors 202 can include a depth sensor and/or a radar sensor that emits a signal in the direction of the physical object 104 and retrieves a response signal as a result of the signal reflecting back from the physical object 104. The sensor 202 determines a distance between the vehicle and the physical object 104 based on a period of elapsed time between emitting the signal and receiving the response signal.

The AR application 210 gathers sensor data from the sensors to generate a virtual model representing the physical object 104 and a position of the physical object 104 in relation to the vehicle. The AR application 210 presents the virtual object on the transparent display 204, such as a HUD, to aid the user 106 in navigating the vehicle in relation to the physical object 104 that is not in the user's line of sight. The virtual model can presented from various viewpoints. For example, the AR application 210 can present the virtual model from an overhead viewpoint, side viewpoint, etc. A user 106 can select and/or change the viewpoint of the virtual model.

The AR application 210 updates the virtual model as the vehicle moves. For example, the AR application 210 can gather updated sensor data from the sensors 202 as the vehicle moves and generate an updated virtual model based on the updated sensor data.

The AR application 210 may also monitor movements of the vehicle to determine an updated position of the vehicle in relation to the physical object 104. For example, the sensors 202 can include sensors that detect motion, such as a gyroscope. The AR application 210 can utilize data gathered from these sensors 202 to determine an update position of the vehicle based on the detected movements.

The AR application 210 updates the virtual model based on the determined updated position of the vehicle in relation to the physical object 104. The AR application 210 presents the updated virtual model on the transparent display 204, thereby providing the user 106 with a continuous depiction of the position of the vehicle in relation to the physical object 104.

The AR application 210 can present navigation instructions for maneuvering the vehicle in relation to the physical object. For example, the navigation instructions can instruct a user 106 in what direction to turn a steering wheel of the vehicle to properly navigate the vehicle in relation to the physical object 104 that is not in the line of sight of the user 106.

The AR application 210 determines the navigation instructions based on the position of the vehicle in relation to the physical object 104 and a navigation goal. The navigation goal indicates an intended motion of the vehicle, such as proceeding forward, parallel parking, turning, etc. The AR application 210 presents the navigation instructions on the transparent display 204 to provide the user 106 with an additional aid in maneuvering the vehicle in relation to the physical object 104.

The AR application 210 can also present the user 106 with an alert indicating that the vehicle is in danger of making contact with a physical object 104. For example, the AR application 210 can utilize the sensor data to determine a distance of the vehicle to a physical object 104. If the AR application 210 determines the distance is less than a threshold distance, the AR application 210 can present an alert message on the transparent display 204. The alert message can alert the user 106 that the vehicle is within the threshold distance of the physical object 104 and is in danger of make physical contact with the physical object 104.

The network 108 may be any network that enables communication between or among machines, databases, and devices (e.g., the head-mounted viewing device 102). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

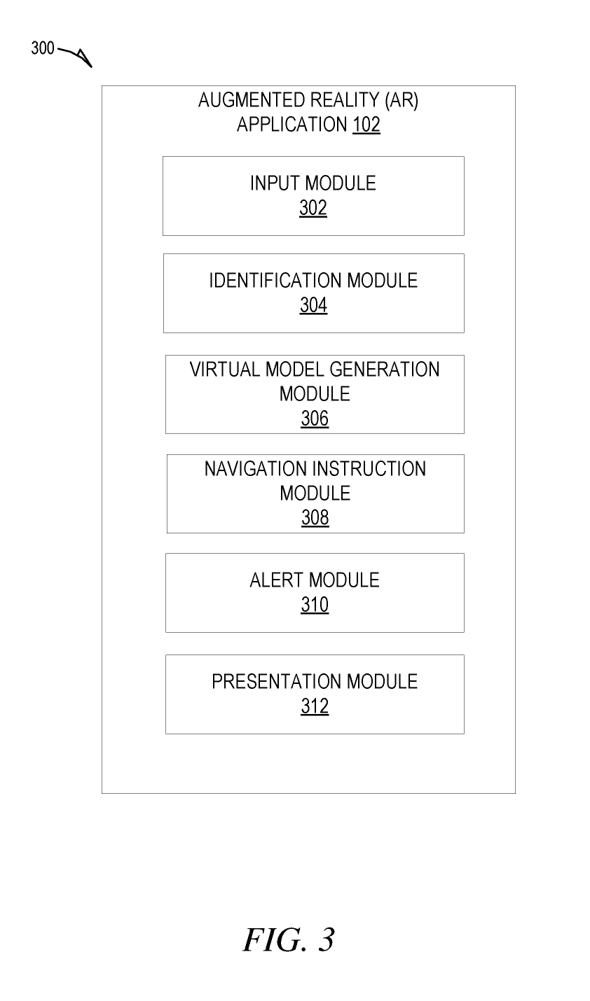

FIG. 3 is a block diagram illustrating an example embodiment of an AR application 210, according to some embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by query manager 120 to facilitate additional functionality that is not specifically described herein. Furthermore, the various functional modules depicted in FIG. 2 may reside on a single computing device or may be distributed across several computing devices in various arrangements such as those used in cloud-based architectures.

As shown, the AR application 210 includes an input module 302, an identification module 304, a virtual model generation module 306, a navigation instruction module 308, an alert module 310 and a presentation module 312.

The input module 302 can receive sensor data from sensors 202 (e.g., an image of the physical object 104, location data, distance to a physical object 104, etc.). The input module 302 can provide the received sensor data to any of the other modules included in the AR application 210.

The identification module 304 can identify a physical object 104 and corresponding virtual content based on an image of the physical object 104 captured by sensors 202 of the viewing device 102. For example, the identification module 304 can determine whether the captured image matches or is similar to an image locally stored by the viewing device 102 in the storage device 206.

The identification module 304 can compare a captured image of the physical object 104 to a local content dataset of images locally stored in the storage device 206 to identify the physical object 104. For example, the identification module 304 can analyze the captured image of a physical object 104 to identify feature points of the physical object. The identification module 304 can utilize the identified feature points to identify the physical object 104 from the local content dataset.

In some embodiments, the identification module 304 can identify a physical object 104 based on a detected visual reference (e.g., a logo or QR code) on the physical object 104 (e.g., a chair). The visual reference may also be referred to as a marker and may consist of an identifiable image, symbol, letter, number, machine-readable code. For example, the visual reference may include a bar code, a quick response (QR) code, or an image that has been previously associated with the virtual content. The local content dataset can include a listing of visual references and corresponding virtual content. The identification module 304 can compare visual references detected in a captured image to the visual references include in the local content dataset.

If the identification module 304 cannot identify a matching image from the local content dataset, the identification module 304 can provide the captured image of the physical object 104 to the server 110 and the server 110 can search a remote content dataset maintained by the server 110.

Once the physical object 104 has been identified, the identification module 304 can access the corresponding virtual content to be presented on the transparent display 204 to augment the user's 106 reality.

The virtual model generation module 306 generates a virtual model of a physical object 104 based on sensor data gathered by the sensors 202. A virtual model can be a three-dimensional model of the physical object 104 or a portion of the physical object 104. For example, a virtual model can depict an entire physical object 104, such as rock, branch, etc., or alternatively, a portion of a physical object 104, such as a portion of a street curb, automobile, etc.

To generate the virtual model, the virtual model generation module 306 utilizes sensor data describing the distance and direction of the physical object 104 from the vehicle. The virtual model generation module 306 utilized the sensor data to determine coordinates defining the outer perimeter of the physical object 104 in relation the vehicle. The virtual model generation module 306 then generates the virtual model based on the coordinates. The generated virtual model can depict the physical object as well as the vehicle.

The virtual model generation module 306 updates the virtual model based on movements of the vehicle and/or the physical object 104. For example, the virtual model generation module 306 can gather updated sensor data from the sensors 202. The updated sensor data can include data describing a distance of the physical object 104 from the vehicle as well as sensor data describing movements of the vehicle. The virtual model generation module 306 can utilize the updated sensor data to determine an updated position of the physical object 104 in relation to the vehicle. The virtual model generation module 306 can update the virtual model to reflect the updated position of the physical object 104 in relation to the vehicle.

The navigation instruction module 308 determines navigation instructions to navigate the vehicle in relation to a physical object 104. For example, the navigation instruction module 308 can determine an action that a user operating the vehicle should take to navigate the vehicle, such as turn in a specific direction, accelerate, brake, etc.

The navigation instruction module 308 can determine the navigation instructions based on the position of the vehicle in relation to the physical object 104 as well as a navigation goal. The navigation instruction module 308 can utilize the virtual model generated by the virtual model generation module 306 to determine the position of the vehicle in relation to the physical object.

The navigation goal indicates an intended motion of the vehicle, such as proceeding forward, parallel parking, turning, etc. The navigation instruction module 308 can determine the navigation goal based on contextual data gathered from the vehicle. The contextual data can include data describing a current motion and direction of the vehicle, what gear the vehicle is in (e.g., drive, reverse, etc.), whether any signals are engaged, the current location of the vehicle, physical objects 104 near the vehicle, etc. For example, the navigation instruction module 308 can determine that the navigation goal is to turn left at an upcoming street if the user 106 has engaged the turn signal. As another example, the navigation instruction module 308 can determine that the navigation goal is to parallel park when the vehicle is in reverse and the vehicle is located within a threshold distance of a curb.

In some embodiments, the user 106 may provide the navigation goal. For example, the viewing device 102 may enable the user to provide input indicating the user's 106 navigation goal, such as parallel parking, turning in a direction, etc.

The navigation instruction module 308 determines navigation instructions to achieve the navigation goal while also avoiding contact with the physical object 104. The navigation instructions include suggested instructions that a user can choose to follow to aid in navigating the vehicle. For example, the navigation instructions can present the user with instructions on a direction to turn a steering wheel, whether to brake or accelerate, etc.

The alert module 310 generates an alert in response to determining that the vehicle is within a threshold distance of a physical object 104. The alert module 310 utilizes sensor data received from the sensors 202 to determine the distance of the vehicle from the physical object 104. The alert module 310 compares the determined distance to a threshold distance. If the distance is less than the threshold distance, the alert module 310 generates an alert notifying the user 106 that the vehicle is within the threshold distance of the physical object 104.

The presentation module 312 can present the virtual content on the transparent display 204. This can include virtual content intended to augment physical objects 104 visible through the transparent display 204, as well as a virtual model generated by the virtual model generation module 306 and alerts generated by alert module 310.

The presentation module 312 further enables a user to adjust the presentation viewpoint of a virtual model generated by the virtual model generation module 306. A user 106 may prefer to view the virtual model from a particular viewpoint, such as an overhead viewpoint, to aid in navigating the vehicle in relation to the physical object. The presentation module 312 further enables the user 106 to adjust a zoom level of the virtual model. The user 106 can therefore zoom in to view a close-up of the physical object 104 in relation to the vehicle, or zoom out from a broader perspective of the vehicle in relation to the physical object.

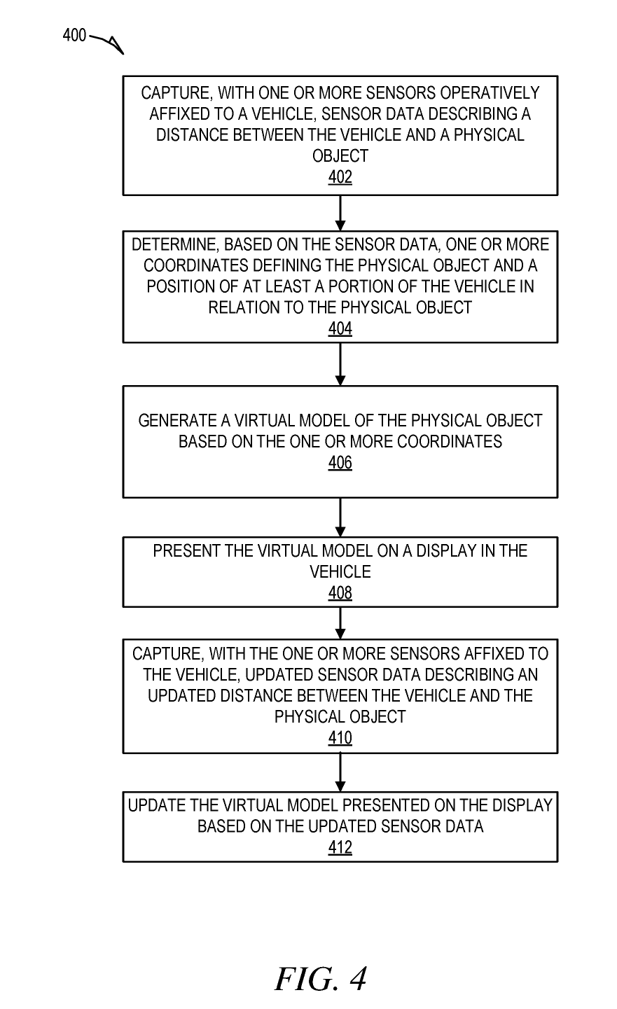

FIG. 4 is an example method 400 for presenting spatially translated dimensions of an unseen object, according to some example embodiments. Method 400 may be embodied in computer readable instructions for execution by one or more processors such that the operations of method 400 may be performed in part or in whole by AR application 210; accordingly, method 400 is described below by way of example with reference thereto. However, it shall be appreciated that at least some of the operations of method 400 may be deployed on various other hardware configurations and method 400 is not intended to be limited to AR application 210.

At operation 402, the sensors 202 capture sensor data describing a distance between the vehicle and a physical object 104. In some embodiments, the vehicle is an automobile and the physical object 104 is a curb. As another example, the vehicle is an automobile and the physical object 104 is a different automobile.

The sensors 202 can determine the distance between the vehicle and physical object 104 by emitting signal in the direction of the physical object 104 and receiving a response signal received as a result of the signal reflecting back from the physical object 104. Examples of sensors 202 that can be used are a depth sensor and radar sensor. The AR application 210 determines, based on the sensor data, the position of at least a portion of the vehicle in relation to the physical object 104.

At operation 404, the virtual model generation module 306 determines, based on the sensor data, one or more coordinates defining the physical object 104 and a position of at least a portion of the vehicle in relation to the physical object 104.

At operation 406, the virtual model generation module 306 generates a virtual model of the physical object 104 based on the one or more coordinates.

At operation 408, the presentation module 312 presents the virtual model on a display (e.g., transparent display 204) of the vehicle. For example, the display may be the front windshield of the vehicle. As another example, the display may be a window of the vehicle that is closest to the physical object 104. For example, if the physical object 104 is behind the vehicle, the presentation module 312 can present the virtual model on the bac windshield. As another example, if the physical object 104 is on the passenger side of the vehicle, the presentation module 312 presents the virtual model on a window on the passenger side of the vehicle.

In some embodiments, the virtual model representing a position of at least the portion of the vehicle in relation to the physical object 104 is presented from an overhead perspective. As another example, the virtual model is presented from a real life perspective. For example, the virtual model may present an extension of the physical object 104 that is visible to the user based on the position of the physical object 104 in relation to the vehicle.

At operation 410, the sensors 202 capture updated sensor data describing an updated distance between the vehicle and the physical object 104.

At operation 412, the virtual model generation module 306 updates the virtual model presented on the display based on the updated sensor data.

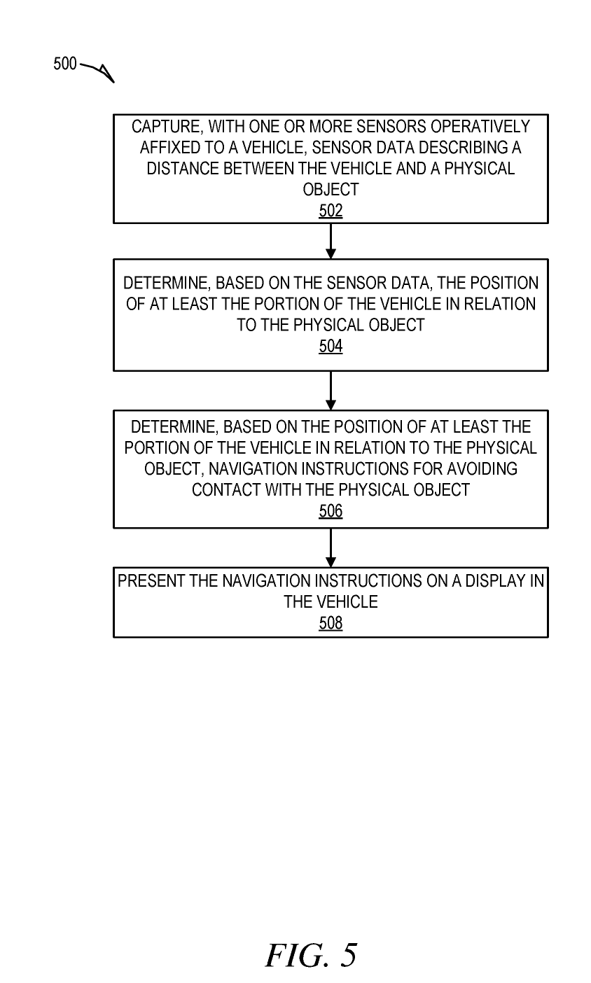

FIG. 5 is an example method 500 for presenting navigation instructions based on an unseen object, according to some example embodiments. Method 500 may be embodied in computer readable instructions for execution by one or more processors such that the operations of method 500 may be performed in part or in whole by AR application 210; accordingly, method 500 is described below by way of example with reference thereto. However, it shall be appreciated that at least some of the operations of method 500 may be deployed on various other hardware configurations and method 500 is not intended to be limited to AR application 210.

At operation 502, the sensors 202 capture sensor data describing a distance between the vehicle and a physical object 104. In some embodiments, the vehicle is an automobile and the physical object 104 is a curb. As another example, the vehicle is an automobile and the physical object 104 is a different automobile.

At operation 504, the navigation instruction module 308 determines, based on the sensor data, the position of at least the portion of the vehicle in relation to the physical object 104.

At operation 506, the navigation instruction module 308 determines, based on the position of at least the portion of the vehicle in relation to the physical object 104, navigation instructions for avoiding contact with the physical object 104.

At operation 508, the presentation module 312 presents the navigation instructions on a display (e.g., transparent display 204) of the vehicle.

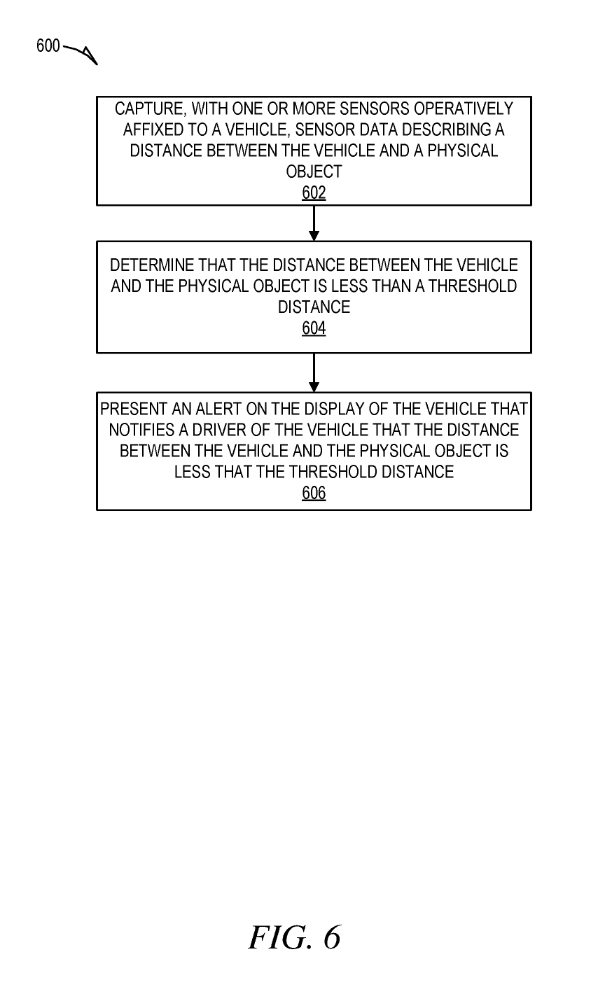

FIG. 6 is an example method 600 for presenting spatially translated dimensions of an unseen object, according to some example embodiments. Method 600 may be embodied in computer readable instructions for execution by one or more processors such that the operations of method 600 may be performed in part or in whole by AR application 210; accordingly, method 600 is described below by way of example with reference thereto. However, it shall be appreciated that at least some of the operations of method 600 may be deployed on various other hardware configurations and method 600 is not intended to be limited to AR application 210.

At operation 602, the sensors 202 capture sensor data describing a distance between the vehicle and a physical object 104. In some embodiments, the vehicle is an automobile and the physical object 104 is a curb. As another example, the vehicle is an automobile and the physical object 104 is a different automobile.

At operation 604, the alert module 310 determines that the distance between the vehicle and the physical object 104 is less than a threshold distance.

At operation 606, the presentation module 312 presents an alert on the display of the vehicle that notifies a driver of the vehicle that the distance between the vehicle and the physical object 104 is less than the threshold distance.

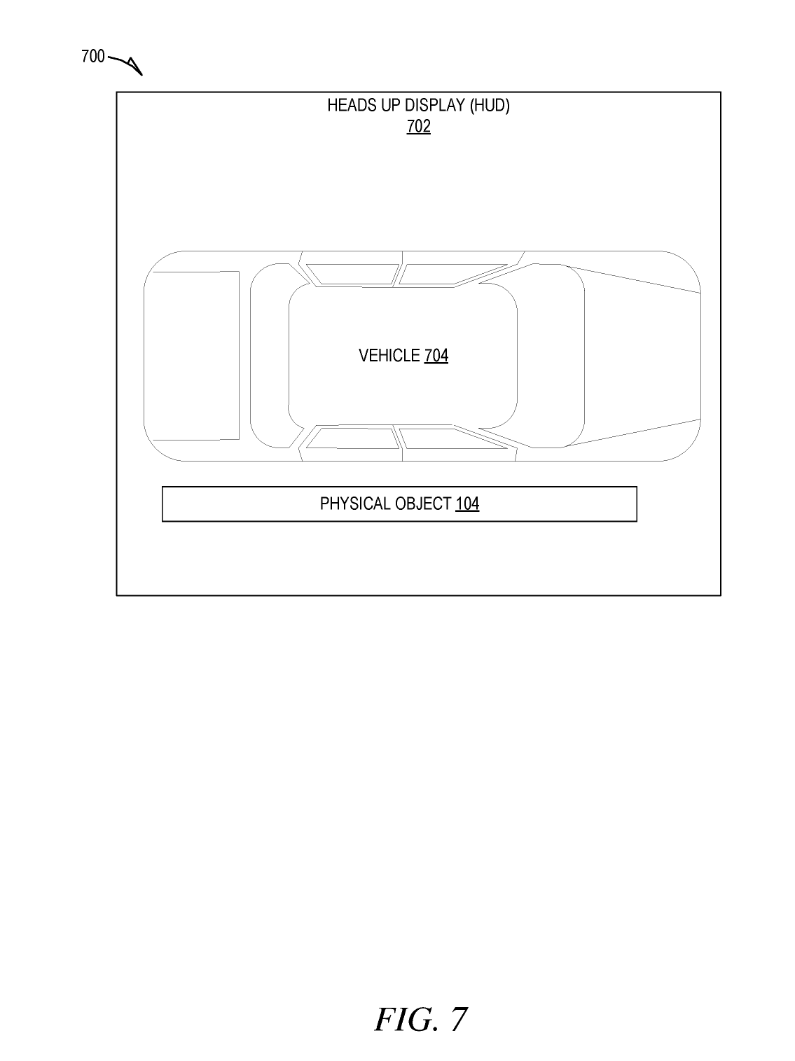

FIG. 7 is a screenshot 700 of a HUD 702 presenting a virtual model of an unseen physical object 104, according to some embodiments. As shown, the HUD 702 is presenting an overhead view of the vehicle 704 in relation to the physical object 104. Further, the virtual model of the vehicle 704 and the physical object 104 are presented as two-dimensional objects. A user 106 operating the vehicle 704 can utilize the virtual model to successfully navigate the vehicle 704 in relation to the physical object 104.

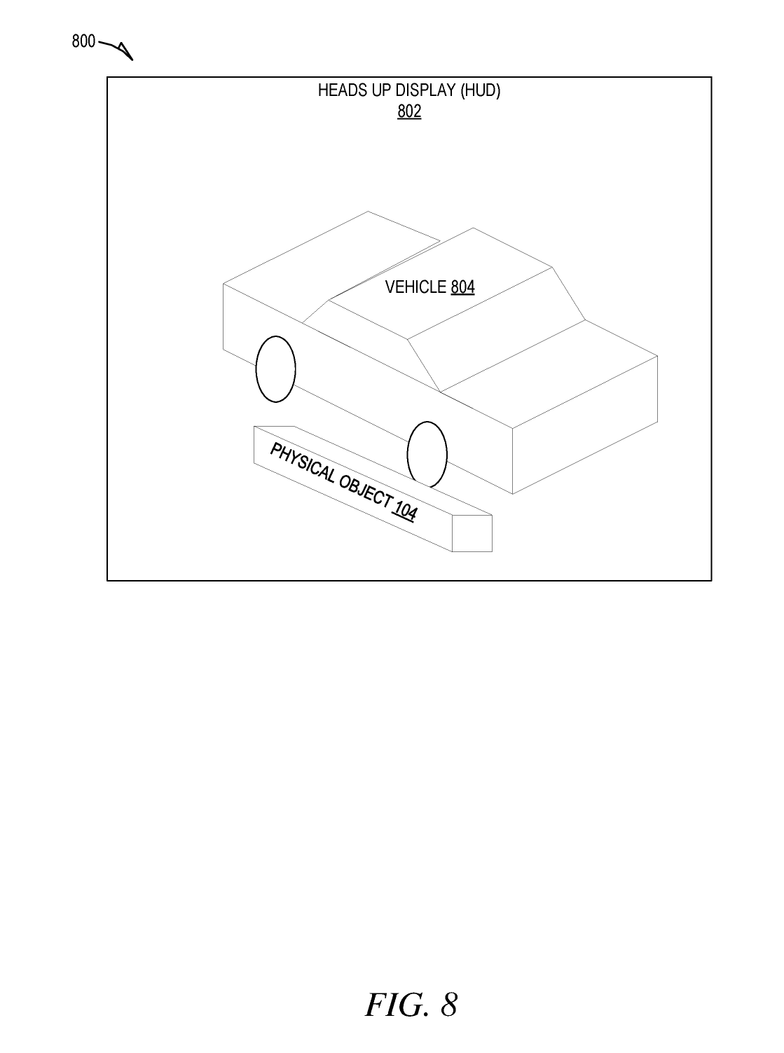

FIG. 8 is another screenshot 800 of a HUD 802 presenting a virtual model of an unseen physical object 104, according to some embodiments. As shown, the HUD 802 is presenting a side view of the vehicle 804 in relation to the physical object 104. Further, the virtual model of the vehicle 804 and the physical object 104 are presented as three-dimensional objects. A user 106 operating the vehicle 804 can utilize the virtual model to successfully navigate the vehicle 804 in relation to the physical object 104.

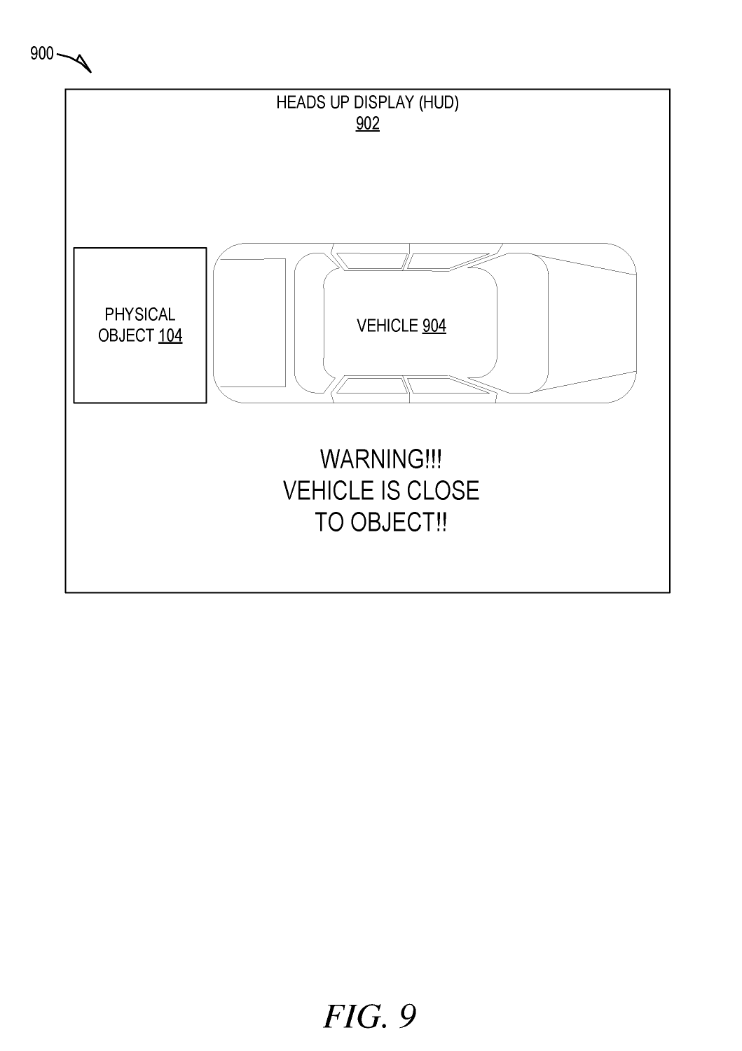

FIG. 9 is screenshot 900 of a HUD 902 presenting a virtual model of an unseen physical object 104 and an alert message, according to some embodiments. As shown, the HUD 902 is presenting an overhead view of the vehicle 904 in relation to the physical object 104. The HUD 902 includes an alert message alerting the user that the vehicle 904 is within a threshold distance of the physical object 104 behind the vehicle and is there in danger of contacting the physical object. A user 106 operating the vehicle 904 can utilize the virtual model and alert message to successfully navigate the vehicle 904 in relation to the physical object 104.

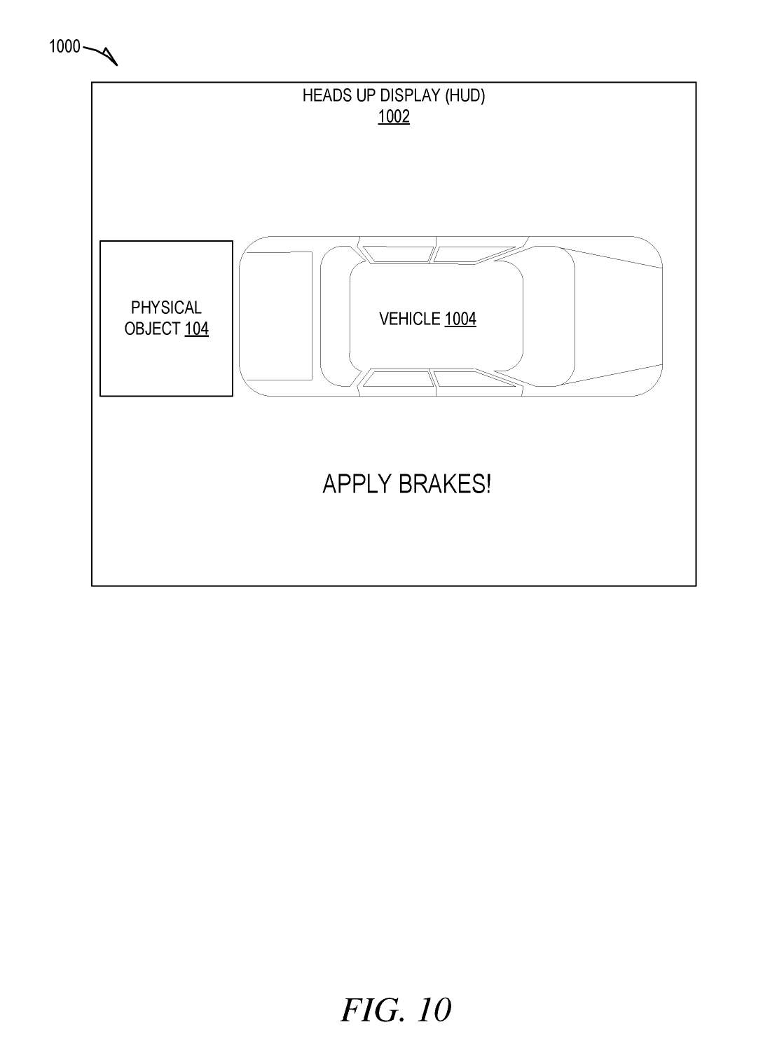

FIG. 10 is screenshot 1000 of a HUD 1002 presenting a virtual model of an unseen physical object 104 and navigation instructions, according to some embodiments. As shown, the HUD 1002 is presenting an overhead view of the vehicle 1004 in relation to the physical object 104. The HUD 1002 includes navigation instructions suggesting that the user apply the brakes to avoid making contact with the physical object 104 located behind the vehicle. A user 106 operating the vehicle 1004 can utilize the virtual model and navigation instructions to successfully navigate the vehicle 1004 in relation to the physical object 104.

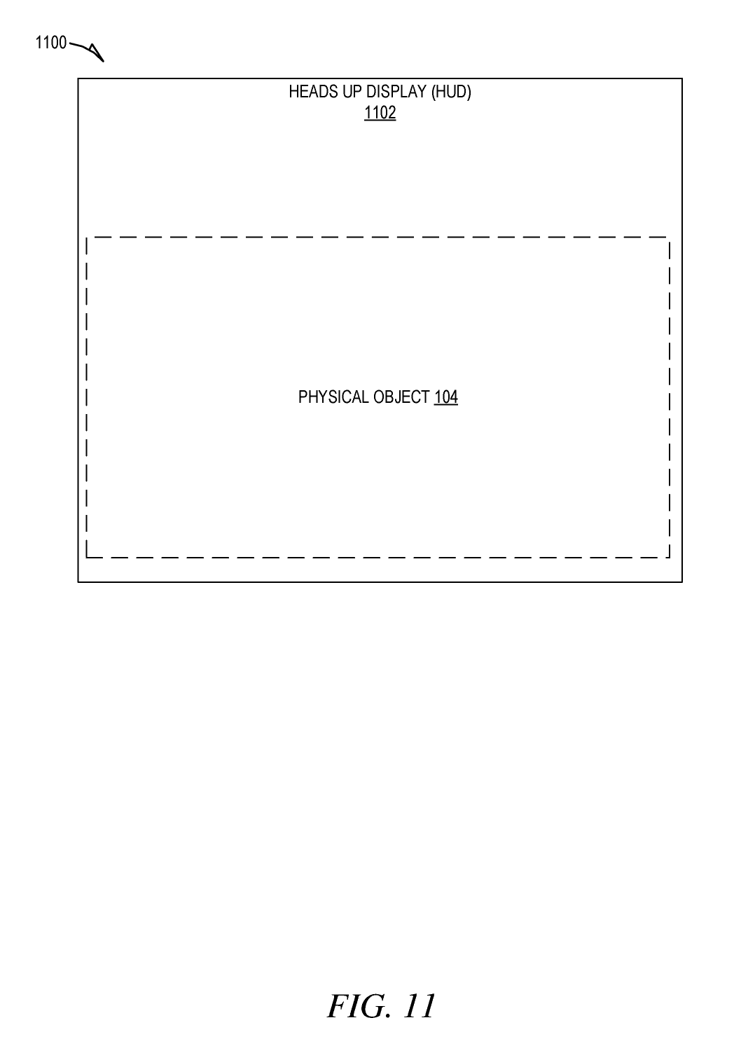

FIG. 11 is screenshot 1100 of a HUD 1102 presenting a virtual model of an unseen physical object 104, according to some embodiments.

As shown, the HUD 1102 is presenting a first person view of the physical object as if though the physical object is visible to the user 106 of the vehicle through the HUD 1102. In this type of embodiments, the physical object 104 may be low to the ground, such as a curb, and out of sight of the user 106. The virtual model presents the physical object 104 to the user 106 at the correct distance, however presents the virtual model in the line of sight of the user. The physical object 104 therefore appears to be extended into the user's 106 line of sight. The virtual model updates the perceived depth of the physical object 104 as the vehicle moves towards and away from the physical object.

The HUD 1102 can be placed on one or more windows of a vehicle. For example, the HUD 1102 can be placed at a side window, rear windshield, front windshield, etc. A user 106 can utilize an appropriate HUD 1102 corresponding to the physical location of the physical object 104 to view the virtual model of the physical object 1045. For example, a user 106 can look over their shoulder towards a street curb and view a virtual model of the street curb extended into the line of sight of the user on the HUD 1102.

### EXAMPLES

Examples can include subject matter such as a method, means for performing acts of the method, at least one machine-readable medium including instructions that, when performed by a machine cause the machine to performs acts of the method, or of an apparatus or system for entity-based routing in a network and between data centers, according to embodiments and examples described herein.

Example 1 is a method comprising: capturing, with one or more sensors operatively affixed to a vehicle, sensor data describing a distance between the vehicle and a physical object; determining, based on the sensor data, one or more coordinates defining the physical object and a position of at least a portion of the vehicle in relation to the physical object; generating a virtual model of the physical object based on the one or more coordinates; presenting the virtual model on a display in the vehicle; capturing, with the one or more sensors, updated sensor data describing an updated distance between the vehicle and the physical object; and updating the virtual model presented on the display based on the updated sensor data.

In Example 2, the subject matter of Example 1 optionally includes wherein capturing sensor data describing the distance between the vehicle and the physical object comprises: emitting, by a first sensor, a signal in the direction of the physical object; receiving, by the first sensor, a response signal received as a result of the signal reflecting back from the physical object; and determining a distance between the vehicle and the physical object based on a period of elapsed time between emitting the signal and receiving the response signal.

In Example 3, the subject matter of any one or more of Examples 1-2 optionally includes wherein the one or more sensors includes a depth sensor.

In Example 4, the subject matter of any one or more of Examples 1-3 optionally includes wherein the one or more sensors includes a radar sensor.

In Example 5, the subject matter of any one or more of Examples 1-4 optionally includes determining, based on the sensor data, the position of at least the portion of the vehicle in relation to the physical object.

In Example 6, the subject matter of any one or more of Examples 1-5 optionally includes determining, based on the position of at least the portion of the vehicle in relation to the physical object, navigation instructions for avoiding contact with the physical object.

In Example 7, the subject matter of any one or more of Examples 1-6 optionally includes determining that the distance between the vehicle and the physical object is less than a threshold distance; and presenting an alert on the display of the vehicle that notifies a driver of the vehicle that the distance between the vehicle and the physical object is less that the threshold distance.

In Example 8, the subject matter of any one or more of Examples 1-7 optionally includes wherein the virtual model representing a position of at least the portion of the vehicle in relation to the physical object is presented from an overhead perspective.

In Example 9, the subject matter of any one or more of Examples 1-8 optionally includes wherein the vehicle is an automobile and the physical object is a curb.

In Example 10, the subject matter of any one or more of Examples 1-9 optionally includes wherein the vehicle is an automobile and the physical object is a different automobile.

Example 11 is a system comprising: one or more computer processors; and one or more computer-readable mediums storing instructions that, when executed by the one or more computer processors, cause the system to perform operations comprising: capturing, with one or more sensors operatively affixed to a vehicle, sensor data describing a distance between the vehicle and a physical object; determining, based on the sensor data, one or more coordinates defining the physical object and a position of at least a portion of the vehicle in relation to the physical object; generating a virtual model of the physical object based on the one or more coordinates; presenting the virtual model on a display in the vehicle; capturing, with the one or more sensors, updated sensor data describing an updated distance between the vehicle and the physical object; and updating the virtual model presented on the display based on the updated sensor data.

In Example 12, the subject matter of Example 11 optionally includes wherein capturing sensor data describing the distance between the vehicle and the physical object comprises: emitting, by a first sensor, a signal in the direction of the physical object; receiving, by the first sensor, a response signal received as a result of the signal reflecting back from the physical object; and determining a distance between the vehicle and the physical object based on a period of elapsed time between emitting the signal and receiving the response signal.

In Example 13, the subject matter of any one or more of Examples 11-12 optionally includes wherein the one or more sensors includes a depth sensor.

In Example 14, the subject matter of any one or more of Examples 11-13 optionally includes wherein the one or more sensors includes a radar sensor.

In Example 15, the subject matter of any one or more of Examples 11-14 optionally includes determining, based on the sensor data, the position of at least the portion of the vehicle in relation to the physical object.

In Example 16, the subject matter of any one or more of Examples 11-15 optionally includes determining, based on the position of at least the portion of the vehicle in relation to the physical object, navigation instructions for avoiding contact with the physical object.

In Example 17, the subject matter of any one or more of Examples 11-16 optionally includes determining that the distance between the vehicle and the physical object is less than a threshold distance; and presenting an alert on the display of the vehicle that notifies a driver of the vehicle that the distance between the vehicle and the physical object is less that the threshold distance.

In Example 18, the subject matter of any one or more of Examples 11-17 optionally includes wherein the virtual model representing a position of at least the portion of the vehicle in relation to the physical object is presented from an overhead perspective.

In Example 19, the subject matter of any one or more of Examples 11-18 optionally includes wherein the vehicle is an automobile and the physical object is a curb.

Example 20 is a non-transitory computer-readable medium storing instructions that, when executed by one or more computer processors of a viewing device, cause the viewing device to perform operations comprising: capturing, with one or more sensors operatively affixed to a vehicle, sensor data describing a distance between the vehicle and a physical object; determining, based on the sensor data, one or more coordinates defining the physical object and a position of at least a portion of the vehicle in relation to the physical object; generating a virtual model of the physical object based on the one or more coordinates; presenting the virtual model on a display in the vehicle; capturing, with the one or more sensors, updated sensor data describing an updated distance between the vehicle and the physical object; and updating the virtual model presented on the display based on the updated sensor data

FIG. 12 is a block diagram illustrating components of a computing device 1200, according to some example embodiments, able to read instructions from a machine-readable medium (e.g., a machine-readable storage medium) and perform any one or more of the methodologies discussed herein. Specifically, FIG. 12 shows a diagrammatic representation of computing device 1200 in the example form of a system, within which instructions 1202 (e.g., software, a program, an application, an applet, an app, a driver, or other executable code) for causing computing device 1200 to perform any one or more of the methodologies discussed herein may be executed. For example, instructions 1202 include executable code that causes computing device 1200 to execute methods 400, 500 and 600. In this way, these instructions transform the general, non-programmed machine into a particular machine programmed to carry out the described and illustrated functions in the manner described herein. Computing device 1200 may operate as a standalone device or may be coupled (e.g., networked) to other machines.

By way of non-limiting example, computing device 1200 may comprise or correspond to a television, a computer (e.g., a server computer, a client computer, a personal computer (PC), a tablet computer, a laptop computer, or a netbook), a set-top box (STB), a personal digital assistant (PDA), an entertainment media system (e.g., an audio/video receiver), a cellular telephone, a smart phone, a mobile device, a wearable device (e.g., a smart watch), a portable media player, or any machine capable of outputting audio signals and capable of executing instructions 1202, sequentially or otherwise, that specify actions to be taken by computing device 1200. Further, while only a single computing device 1200 is illustrated, the term “machine” shall also be taken to include a collection of computing devices 1200 that individually or jointly execute instructions 1202 to perform any one or more of the methodologies discussed herein.

Computing device 1200 may include processors 1204, memory 1206, storage unit 1208 and I/O components 1210, which may be configured to communicate with each other such as via bus 1212. In an example embodiment, processors 1204 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, processor 1214 and processor 1216 that may execute instructions 1202. The term “processor” is intended to include multi-core processors that may comprise two or more independent processors (sometimes referred to as “cores”) that may execute instructions contemporaneously. Although FIG. 12 shows multiple processors, computing device 1200 may include a single processor with a single core, a single processor with multiple cores (e.g., a multi-core process), multiple processors with a single core, multiple processors with multiples cores, or any combination thereof.

Memory 1206 (e.g., a main memory or other memory storage) and storage unit 1208 are both accessible to processors 1204 such as via bus 1212. Memory 1206 and storage unit 1208 store instructions 1202 embodying any one or more of the methodologies or functions described herein. In some embodiments, database 1216 resides on storage unit 1208. Instructions 1202 may also reside, completely or partially, within memory 1206, within storage unit 1208, within at least one of processors 1204 (e.g., within the processor's cache memory), or any suitable combination thereof, during execution thereof by computing device 1200. Accordingly, memory 1206, storage unit 1208, and the memory of processors 1204 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), or any suitable combination thereof. The term “machine-readable medium” should be taken to include a single medium or multiple media (e.g., a centralized or distributed database, or associated caches and servers) able to store instructions 1202. The term “machine-readable medium” shall also be taken to include any medium, or combination of multiple media, that is capable of storing instructions (e.g., instructions 1202) for execution by a machine (e.g., computing device 1200), such that the instructions, when executed by one or more processors of computing device 1200 (e.g., processors 1204), cause computing device 1200 to perform any one or more of the methodologies described herein (e.g., methods 400, 500 and 600). Accordingly, a “machine-readable medium” refers to a single storage apparatus or device, as well as “cloud-based” storage systems or storage networks that include multiple storage apparatus or devices. The term “machine-readable medium” excludes signals per se.

Furthermore, the “machine-readable medium” is non-transitory in that it does not embody a propagating signal. However, labeling the tangible machine-readable medium as “non-transitory” should not be construed to mean that the medium is incapable of movement—the medium should be considered as being transportable from one real-world location to another. Additionally, since the machine-readable medium is tangible, the medium may be considered to be a machine-readable device.

The I/O components 1210 may include a wide variety of components to receive input, provide output, produce output, transmit information, exchange information, capture measurements, and so on. The specific I/O components 1210 that are included in a particular machine will depend on the type of machine. For example, portable machines such as mobile phones will likely include a touch input device or other such input mechanisms, while a headless server machine will likely not include such a touch input device. It will be appreciated that I/O components 1210 may include many other components that are not specifically shown in FIG. 12. I/O components 1210 are grouped according to functionality merely for simplifying the following discussion and the grouping is in no way limiting. In various example embodiments, I/O components 1210 may include input components 1218 and output components 1220. Input components 1218 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components, and the like. Output components 1220 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth.

Communication may be implemented using a wide variety of technologies. I/O components 1210 may include communication components 1222 operable to couple computing device 1200 to network 1224 or devices 1226 via coupling 1228 and coupling 1230, respectively. For example, communication components 1222 may include a network interface component or other suitable device to interface with network 1224. In further examples, communication components 1222 may include wired communication components, wireless communication components, cellular communication components, near field communication (NFC) components, Bluetooth® components (e.g., Bluetooth® Low Energy), WiFi® components, and other communication components to provide communication via other modalities. The devices 1226 may be another machine or any of a wide variety of peripheral devices (e.g., a peripheral device coupled via a Universal Serial Bus (USB)).

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Language

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A method comprising:
capturing, with one or more sensors operatively affixed to a vehicle, sensor data describing a distance between the vehicle and a physical object;
determining, based on the sensor data, one or more coordinates defining the physical object and a position of at least a portion of the vehicle in relation to the physical object;
generating a virtual model of the physical object based on the one or more coordinates;
presenting the virtual model on a display in the vehicle;
capturing, with the one or more sensors, updated sensor data describing an updated distance between the vehicle and the physical object; and
updating the virtual model presented on the display based on the updated sensor data.

2. The method of claim 1, wherein capturing sensor data describing the distance between the vehicle and the physical object comprises:
emitting, by a first sensor, a signal in the direction of the physical object;
receiving, by the first sensor, a response signal received as a result of the signal reflecting back from the physical object; and
determining a distance between the vehicle and the physical object based on a period of elapsed time between emitting the signal and receiving the response signal.

3. The method of claim 1, wherein the one or more sensors includes a depth sensor.

4. The method of claim 1, wherein the one or more sensors includes a radar sensor.

5. The method of claim 1, further comprising:
determining, based on the sensor data, the position of at least the portion of the vehicle in relation to the physical object.

6. The method of claim 5, further comprising:
determining, based on the position of at least the portion of the vehicle in relation to the physical object, navigation instructions for avoiding contact with the physical object.

7. The method of claim 1, further comprising:
determining that the distance between the vehicle and the physical object is less than a threshold distance; and
presenting an alert on the display of the vehicle that notifies a driver of the vehicle that the distance between the vehicle and the physical object is less that the threshold distance.

8. The method of claim 1, wherein the virtual model representing a position of at least the portion of the vehicle in relation to the physical object is presented from an overhead perspective.

9. The method of claim 1, wherein the vehicle is an automobile and the physical object is a curb.

10. The method of claim 1, wherein the vehicle is an automobile and the physical object is a different automobile.

11. A system comprising:
one or more computer processors; and
one or more computer-readable mediums storing instructions that, when executed by the one or more computer processors, cause the system to perform operations comprising:
capturing, with one or more sensors operatively affixed to a vehicle, sensor data describing a distance between the vehicle and a physical object;
determining, based on the sensor data, one or more coordinates defining the physical object and a position of at least a portion of the vehicle in relation to the physical object;
generating a virtual model of the physical object based on the one or more coordinates;
presenting the virtual model on a display in the vehicle;
capturing, with the one or more sensors, updated sensor data describing an updated distance between the vehicle and the physical object; and
updating the virtual model presented on the display based on the updated sensor data.

12. The system of claim 11, wherein capturing sensor data describing the distance between the vehicle and the physical object comprises:
emitting, by a first sensor, a signal in the direction of the physical object;
receiving, by the first sensor, a response signal received as a result of the signal reflecting back from the physical object; and
determining a distance between the vehicle and the physical object based on a period of elapsed time between emitting the signal and receiving the response signal.

13. The system of claim 11, wherein the one or more sensors includes a depth sensor.

14. The system of claim 11, wherein the one or more sensors includes a radar sensor.

15. The system of claim 11, the operations further comprising:
determining, based on the sensor data, the position of at least the portion of the vehicle in relation to the physical object.

16. The system of claim 15, the operations further comprising:
determining, based on the position of at least the portion of the vehicle in relation to the physical object, navigation instructions for avoiding contact with the physical object.

17. The system of claim 11, the operations further comprising:
determining that the distance between the vehicle and the physical object is less than a threshold distance; and
presenting an alert on the display of the vehicle that notifies a driver of the vehicle that the distance between the vehicle and the physical object is less that the threshold distance.

18. The system of claim 11, wherein the virtual model representing a position of at least the portion of the vehicle in relation to the physical object is presented from an overhead perspective.

19. The system of claim 11, wherein the vehicle is an automobile and the physical object is a curb.

20. A non-transitory computer-readable medium storing instructions that, when executed by one or more computer processors of a viewing device, cause the viewing device to perform operations comprising:
capturing, with one or more sensors operatively affixed to a vehicle, sensor data describing a distance between the vehicle and a physical object;
determining, based on the sensor data, one or more coordinates defining the physical object and a position of at least a portion of the vehicle in relation to the physical object;
generating a virtual model of the physical object based on the one or more coordinates;
presenting the virtual model on a display in the vehicle;
capturing, with the one or more sensors, updated sensor data describing an updated distance between the vehicle and the physical object; and
updating the virtual model presented on the display based on the updated sensor data.
